(19) United States
(12) Patent Application Publication
(10) Pub. No.: US 2015/0057215 A1
(43) Pub. Date: Feb. 26, 2015

(54) SOAP KIT FOR ASSSEMBLY

(71) Applicants: Willy Mizrachi, Tel Aviv (IL); Jonathan Roth, Pardes Hanna (IL); Galit Shvo, Tel Aviv (IL)

(72) Inventors: Willy Mizrachi, Tel Aviv (IL); Jonathan Roth, Pardes Hanna (IL); Galit Shvo, Tel Aviv (IL)

(21) Appl. No.: 14/363,028

(22) PCT Filed: Dec. 3, 2012
(86) PCT No.: PCT/IL2012/050495

§ 371 Date: Jun. 5, 2014

Related U.S. Application Data
(60) Provisional application No. 61/567,131, filed on Dec. 6, 2011.

(51) Int. Cl. C11D 17/00; C11D 3/50; C11D 17/04

(52) U.S. Cl. CPC C11D 17/0047; C11D 17/04; C11D 3/50
USPC 510/440; 510/445; 156/293

(57) ABSTRACT

A soap kit that includes a plurality of soap pieces for assembly. Each soap piece is configured to engage with a geometrically conforming portion of at least another complementary soap piece, such that the soap pieces can be collectively arranged to form a unified integrated soap unit. The soap pieces may be engaged with one another while in a wet state to facilitate their adhesion. The soap pieces may then be transitioned from a wet state to a dry state to reinforce the adhesion and facilitate solidification of the soap unit. The integrated soap unit may depict a representation of an image or constitute a representation of an object.

### FIELD OF THE DISCLOSED TECHNIQUE

The disclosed technique relates to novelty products and to soap bars.

### BACKGROUND OF THE DISCLOSED TECHNIQUE

It is common knowledge that maintaining a certain level of hygiene is of high importance to prevent the spreading of diseases. Children are particularly susceptible to an increased risk of infections or contagions as their immune system is still at an early stage of development. The latter fact becomes of greater significance when considering that children usually exhibit a propensity to get dirty, as they tend to contact potentially contaminated items and surfaces while playing and physically interacting with other playfellows. Thus, children are typically more often exposed to matter (e.g., dirt) that might comprise a large population of pathogenic microorganisms having the potential of adversely affecting their health. It is well known that any of a group of organic compounds that are salts of fatty acids, when dissolved in water, facilitates cleaning away microorganisms from a surface such as the human skin. Such a group of organic compounds are generally referred to as a “soap” or “cleansing agent”.

In view of the aforesaid, it is evident that in order to ensure that a child's health will not be adversely affected, such as by contracting an infection resulting from exposure to contaminants or pathogenic bacteria, the child should be encouraged to consistently clean and wash himself with soap as a basic means for maintaining a minimum level of hygiene. However, children may loath the usage of soap products and, in particular, the usage of soap bars. A number of soap products have thus been devised in a manner to attempt to entice children to use soap products for washing or bathing.

U.S. Pat. No. 5,183,429 to Bitton, entitled “Children's toy and bath soap assembly”, discloses a waterproof toy or figurine that is encapsulated inside a transparent soap, which is itself encased inside a transparent soap container. The toy has an irregular shape representing an object (e.g., a teddy bear, a mermaid, a dinosaur), while the soap is configured to conform to the toy shape, and preferably complement the object represented by the toy. The soap container is made of plastic and conforms to the soap shape, and may serve as a soap dish, a toy, or a storage container. The soap or the soap container may be further colored or tinted. The entire toy is fully visible through both the soap and the soap container, allowing a child to select a desired toy and providing an incentive for the child to bathe with the soap in order to access the toy.

U.S. Pat. No. 5,887,410 to Lowenthal, entitled “Method of molding and packaging of a novelty soap”, discloses a packaging process for a bar of soap containing an embedded item. A premium item, such as a child's toy, is positioned into a transparent PVC plastic container or “blister package”. The soap is then cast into the container by pouring a transparent glycerin-based liquid soap material into the container and leaving it to cool, thereby embedding the item within the soap. The container is then bonded to a backing card, which may contain text or graphics relating to the soap or premium item.

U.S. Pat. No. 5,971,827 to Lee et al, entitled “Novelty soap”, discloses a transparent soap bar that incorporates an electromechanical attractor module, such as an animated display, toy or game. The attractor module includes a sealed water-proof rectangular outer shell with a transparent front portion. The shell contains an electronic circuit adapted to emit a visible and/or audible signal, and a battery. A light sensitive switch prevents activation of the circuit in the absence of sufficient ambient light, while a motion sensitive switch activates the circuit upon detecting motion of the soap bar. The attractor module may produce an animated sequence visible through the soap bar, e.g., via an LED lighting sequence, an LCD display sequence, reflective sheets, or an electromechanical carousel.

### SUMMARY OF THE DISCLOSED TECHNIQUE

In accordance with one aspect of the disclosed technique, there is thus provided a soap kit that includes a plurality of soap pieces for assembly. Each one of the soap pieces is configured to engage with a geometrically conforming portion of at least another complementary one of the soap pieces, such that the soap pieces can be collectively arranged to form an integrated soap unit. A complementary group of the soap pieces may be engaged while at least one of the complementary group of the soap pieces is in a wet state, to facilitate their adhesion. At least one of the complementary group of soap pieces may be transitioned from a wet state to a dry state, to reinforce the adhesion and to facilitate solidification of the soap unit. The soap unit may depict a representation of an image. The soap unit may constitute a representation of an object. The soap unit may erode over time, changing the appearance of its representation. The erosion of the soap unit may reveal a representation of at least one new image or object by the soap unit. The erosion of the soap unit at different stages may reveal a sequential pattern of images or objects by the soap unit. The soap pieces may be configured as a two-dimensional or three-dimensional tiling puzzle, such that the integrated soap unit represents a completed puzzle. At least one of the soap pieces may include at least one indentation that geometrically conforms with a portion of at least another complementary one of the soap pieces. The complementary one of the soap pieces may be frictionally retained within a corresponding indentation during assembly. A complementary group of the soap pieces may include at least one coupling mechanism, such as: complementary ridges and grooves, complementary tabs and recesses, complementary interlocking portions, or adhesive coatings. At least one of the soap pieces may be a scented soap piece. The soap kit may include at least one supplementary non-soap component, configured to engage with a geometrically conforming portion of at least one of the soap pieces.

In accordance with another aspect of the disclosed technique, there is thus provided a method for assembling a plurality of soap pieces into an integrated soap unit. The method includes the procedure of collectively arranging the soap pieces of a soap kit relative to one another, by engaging at least one of the soap pieces with a geometrically conforming portion of at least another complementary one of the soap pieces. The method may further include the procedure of wetting at least one of a complementary group of the soap pieces prior to engaging the complementary group of soap pieces, to facilitate their adhesion. The method may further include the procedure of transitioning at least of the soap pieces from a wet state to a dry state, to reinforce the adhesion and to facilitate solidification of the soap unit.

### BRIEF DESCRIPTION OF THE DRAWINGS

The disclosed technique will be understood and appreciated more fully from the following detailed description taken in conjunction with the drawings in which:

FIG. 1 is a perspective view schematic illustration of a soap kit constructed and operative in accordance with an embodiment of the disclosed technique;

FIG. 2 is a perspective view schematic illustration of a perspective view of an integrated soap unit assembled from the soap kit of FIG. 1;

FIG. 3 is a perspective view schematic illustration of the soap unit of FIG. 2 having undergone an initial stage of erosion, constructed and operative in accordance with an embodiment of the disclosed technique;

FIG. 4 is a perspective view schematic illustration of the soap unit of FIG. 3 transitioning into a further eroded state, constructed and operative in accordance with an embodiment of the disclosed technique; and

FIG. 5 is a schematic illustration of a soap kit with scented and unscented soap pieces, constructed and operative in accordance with another embodiment of the disclosed technique.

### DETAILED DESCRIPTION OF THE EMBODIMENTS

The disclosed technique overcomes the disadvantages of the prior art by providing a novel soap kit that includes a plurality of soap pieces for assembly, where each soap piece is configured to geometrically conform to a portion of at least another soap piece.

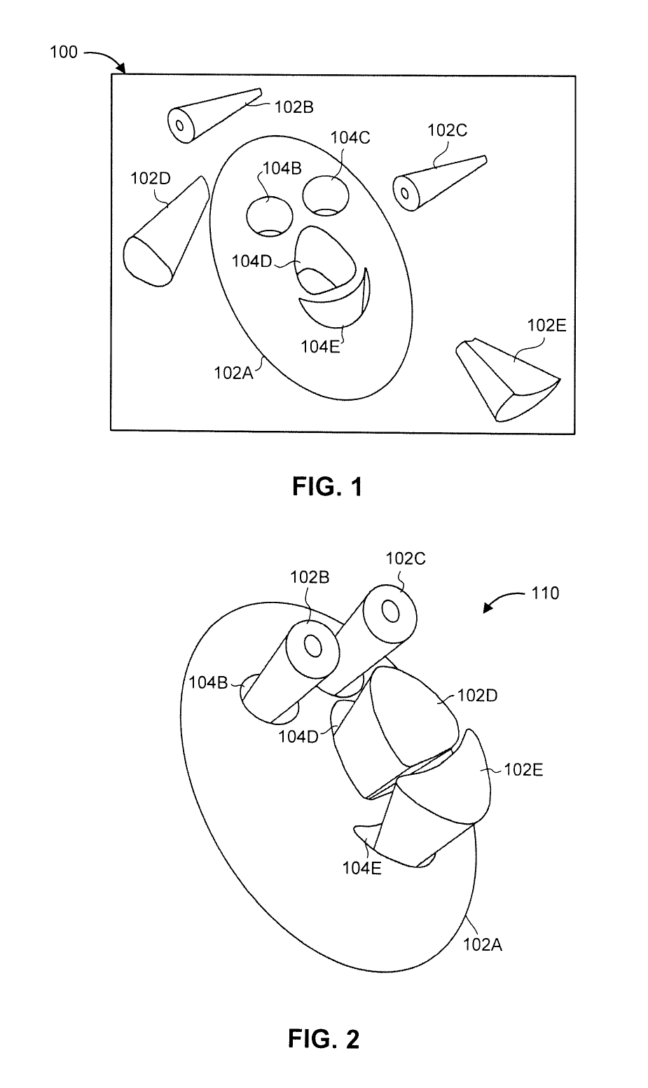

Reference is now made to FIG. 1, which is a perspective view schematic illustration of a soap kit, referenced 100, constructed and operative in accordance with an embodiment of the disclosed technique. Soap kit 100 includes a plurality of soap pieces 102A, 102B, 102C, 102D and 102E, which for simplicity are also referenced herein collectively as soap pieces 102. Each soap piece 102 is configured such that a portion thereof geometrically conforms to a portion of at least another soap piece 102 of soap kit 100. In particular, soap piece 102A includes a plurality of indentations 104B, 104C, 104D and 104E (collectively referenced 104), where each indentation 104 is adapted to engage with a portion of a respective soap piece 102. For example, the shape and size of each indentation 104B, 104C, 104D, 104E substantially corresponds with (i.e., “geometrically conforms with”) the shape and size of at least one end of the respective soap pieces 102B, 102C, 102D, 102E, such that a given soap piece securely fits within the respective indentation. Accordingly, the soap pieces 102 of soap kit 100 may be assembled to form an integrated soap unit by: positioning soap piece 102B into soap indentation 104B, positioning soap piece 102C into soap indentation 104C, positioning soap piece 102D into soap indentation 104D, and positioning soap piece 102E into soap indentation 104E. Reference is now made to FIG. 2, which is a perspective view of an integrated soap unit, generally referenced 110, assembled from the soap kit 100 of FIG. 1. Soap kit 100 represents an exemplary embodiment of the disclosed technique in which a base soap piece 102A is formed to resemble a head, while soap pieces 102B and 102C are formed to resemble eyes, soap piece 102D is formed to resemble a nose, and soap piece 102E is formed to resemble a mouth. As a result, the integrated soap unit 110 is configured to schematically depict facial features, and thus resembles a representation of a face. It is appreciated that additional or alternative designs may also be represented by integrated soap units and/or by the individual soap pieces of a soap kit in accordance with the disclosed technique.

According to an embodiment of the disclosed technique, the soap pieces may be configured as a two-dimensional or three-dimensional tiling puzzle. Correspondingly, the soap pieces may be arranged relative to one another (e.g., in a non-overlapping manner and without gaps) to form an integrated soap unit that represents a completed puzzle. Each soap piece is thus sized and shaped to geometrically conform with another soap piece in a certain way, such that the completed unit forms a predetermined shape or pattern and/or depicts a particular visual representation. For example, each soap piece may depict a portion of a picture or image, such that the assembled soap unit depicts a visual representation of the entire picture or image. Alternatively, each soap piece may constitute a portion of an object, such that the assembled soap unit constitutes a completely formed object.

According to an embodiment of the disclosed technique, the soap pieces of an individual soap kit may be configured in a manner such that they can be assembled into any number of possible integrated soap units (e.g., each soap unit depicting a respective picture and/or constituting a respective object). Alternatively, the soap pieces may be configured such that they can be assembled to form only one specific type of integrated soap unit (such as soap unit 110). For example, a portion of a first soap piece (e.g., soap piece 102B) may geometrically conform only to one specific portion of a second soap piece (e.g., soap piece 102A). Alternatively, a portion of a first soap piece may geometrically conform to two or more portions of at least one other soap piece in the soap kit. The soap pieces may be configured to be coupled with other soap pieces in more than one way, while still being designed to be assembled into one particular integrated soap unit.

In order to facilitate the adhesion of the soap pieces to one another, they may be wetted beforehand, partially or entirely. Referring to FIGS. 1 and 2, the assembly of soap pieces 102 to form integrated soap unit 110 may involve transitioning soap pieces 102 from a dry state to a wet state by wetting the dry soap pieces (e.g., applying them with water or other liquid). As a result, the wet surfaces of soap pieces 102 may at least partially dissolve and become sticky, assisting them to adhere with one another. For example, water may be applied to indentation 104B of soap piece 102A as well as to the geometrically conforming portion of soap piece 102B, before positioning soap piece 102B into indentation 104B, thereby adhesively coupling soap pieces 102A and 102B. The soap pieces 102 to be coupled may be wetted before and/or after their coupling to achieve facilitated adhesion. All the soap pieces of a soap kit may be wetted initially, before commencing assembly of the soap pieces, or each soap piece may be wetted individually as required. According to an embodiment of the disclosed technique, a user of the soap kit performs the assembly while taking a shower or a bath, where the availability of water allows for facilitating the adhesive coupling of the respective soap pieces in a convenient manner.

After their adhesion, the soap pieces may be transitioned from a wet state to a dry state, in order to facilitate the solidification of the various soap pieces to integrally form a unified soap unit. For example, after the wet soap pieces 102B, 102C, 102D, 102E are adhesively coupled with soap piece 102A, all of the soap pieces 102 are dried, causing them to gradually coagulate and harden to form a unified integrated soap unit 110, while reinforcing their adhesion and substantially preventing unit 110 from inadvertently breaking or disassembling back into separate components. The soap unit may also take on a different visual appearance upon drying. It is noted that the geometrically conforming nature of soap pieces 102 further serves to facilitate their adhesion, by ensuring that the respective soap pieces remain substantially in a fixed position until their drying and consequent solidification has been completed.

It is noted that any one of indentations 104 may extend entirely through the base soap piece 102A, i.e., defining a hole, allowing the respective soap piece 102 to be inserted through the indentation 104 from more than one side of soap piece 102A. Accordingly, a soap piece 102 of the soap kit 100 may be configured to penetrate through such a hole and to protrude from one side of the base soap piece 102A, which may provide a corresponding aesthetic or functional value, such as the figuration of an animal tail. Other soap pieces may be configured to be coupled with the protruding portion of the protruding soap piece. An indentation 104 may alternatively extend only partially into base soap piece 102A, such that the thickness of the indentation interior is less than the maximum thickness of base soap piece 102A, defining an inner surface that substantially matches the size and shape of at least one surface of another soap piece 102. The soap pieces 102 and indentations 104 may be configured such that a soap piece 102 will be frictionally retained within its respective indentation 104 during assembly.

Rather than being formed with projections and indentations, soap pieces may be adapted to engage with one another in alternative ways in accordance with other embodiments of the disclosed technique. For example, soap pieces may include certain regions configured to latch onto or otherwise engage with a complementary region of other soap pieces in the soap kit, or may include particular coupling mechanisms, such as: complementary ridges and grooves, complementary tabs and recesses, complementary interlocking portions (e.g., a hook and a corresponding loop), adhesive coatings, and the like. A coupling portion may be situated only on a surface or perimeter of the soap piece such that the soap pieces are coupled along the respective surface or perimeter, or alternatively, the soap pieces may be configured to latch into or through one another. The coupling portions of the soap pieces may also simultaneously provide a depiction of visual features for the assembled soap unit (e.g., a representation of ears or hair to the face depiction of soap unit 110). The soap pieces may engage with one another using any suitable set of actions or maneuvers, such as a twisting motion to screw one piece into another, multidirectional translational shifts to latch pieces with one another, and the like. The soap pieces are generally adapted to allow for straightforward manual assembly, without requiring any special dexterity or technical skill and without any supplementary tools, although such tools may also be utilized if so chosen. According to an embodiment of the disclosed technique, the soap kit may include an instruction manual providing a detailed explanation for how to properly assemble the soap pieces in the soap kit to produce the integrated soap unit. For example, the instructions may include an ordered list of steps along with corresponding illustrations.

While soap unit 110 of FIGS. 1 and 2 is shown to schematically depict a representation of a smiling face, the assembled soap pieces may be configured to depict an alternative type of image or pattern (i.e., a two-dimensional representation) and/or to constitute a type of object (i.e., a three-dimensional representation), including but not limited to: a non-smiling face (e.g., an angry or sad face); a vehicle (e.g., a car, a motorcycle, an airplane); an animal (e.g., a dog, a horse, a butterfly); an occupational professional (e.g., a clown, an astronaut, a soldier); a likeness of a real or fictional individual or group of people (e.g., a popular musician or athlete, cartoon characters); a representation of a building or monument (e.g., Eiffel Tower, Statue of Liberty), and the like.

It is understood that although soap kit 100 is shown to include only five soap pieces 102, any number of soap pieces may be included in a soap kit in accordance with the disclosed technique. It is also understood that the geometrical configuration of soap pieces 102 are exemplary, and that soap pieces of the disclosed technique may have different sizes, shapes or other characteristics than those depicted in FIGS. 1 and 2.

The soap pieces of the disclosed technique are generally formed as solid soap material, such as the common “bar soap” (i.e., as opposed to “liquid soap”). The soap pieces may be made from any suitable material and soap manufacturing process known in the art, such as: etching, cutting, molding, milling, melting, sintering, compression, and any combination thereof. The integrated soap unit is operative to be used in a typical manner as a regular soap, such as for washing, bathing or cleaning with. The integrated soap unit may also be used for aesthetic or ornamental purposes.

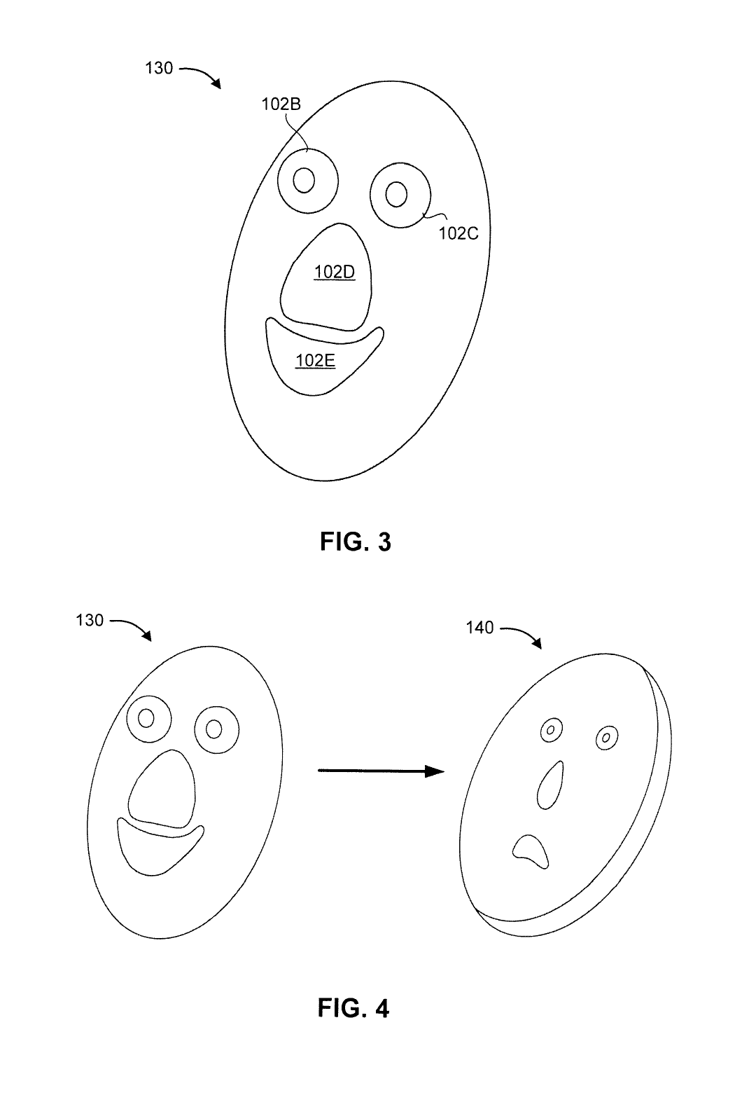

According to an embodiment of the disclosed technique, the erosion of an integrated soap unit over time may result in a change in its visual representation. Reference is now made to FIG. 3, which is a perspective view schematic illustration of the soap unit of FIG. 2 having undergone an initial stage of erosion, constructed and operative in accordance with an embodiment of the disclosed technique. The eroded soap unit of FIG. 3, generally referenced 130, has soap pieces 102B, 102C, 102D, 102E that have been gradually worn down, such as due to prolonged usage of the soap. As a result, the soap pieces 102 of soap unit 130 have become embedded into the respective indentations, rather than projecting outwards as in soap unit 110 (FIG. 2). The facial features represented by soap pieces 102 therefore appear different in soap unit 130 as compared to soap unit 110.

Reference is now made to FIG. 4, which is a perspective view schematic illustration of the soap unit 130 of FIG. 3 transitioning into a further eroded state, constructed and operative in accordance with an embodiment of the disclosed technique. The eroded soap unit of FIG. 4, generally referenced 140, has soap pieces 102 which have further eroded and become worn down, compared to the soap pieces 102 of soap unit 130. The act of using soap unit 130 in a typical manner, such as for washing, bathing or cleaning, particularly by repeatedly wetting and rubbing soap unit 130, serves to gradually erode its exterior layers. Soap pieces 102 may be configured such that formative and/or visual changes occur during erosion of soap unit 130 to gradually reveal a new image and/or object. For example, following a sufficient degree of erosion, the happy face image depicted by soap unit 130 transitions into a sad face image depicted by soap unit 140.

According to an embodiment of the disclosed technique, the soap pieces may be configured such that various images, patterns and/or objects may be gradually and successively revealed as the erosion of the soap unit proceeds. For example, the soap pieces are configured such that a first inner layer of the soap unit provides a visual representation of a first image (e.g., a sad face), a second external layer provides a visual representation of a second image (e.g., an angry face), while a third external layer provides a visual representation of a third image (e.g., a confused face). As a result, the successive erosion of each layer reveals the image representation of the subsequent layer directly underneath. The soap pieces may also be configured such that different images, patterns and/or objects are revealed depending on the amount and/or the location of the erosion of the soap unit. For example, the soap pieces are configured such that the soap unit will depict a visual representation of a first image if the right-side portion of the soap unit undergoes significant erosion, while depicting a visual representation of a second image if the left-side portion of the soap unit undergoes significant erosion. The soap unit may depict a number of intermediate transitional images, where each image represents a different stage of a sequential pattern or transition (e.g., a sad face turning into an angry face turning into a happy face, or a flower turning into a caterpillar turning into a butterfly).

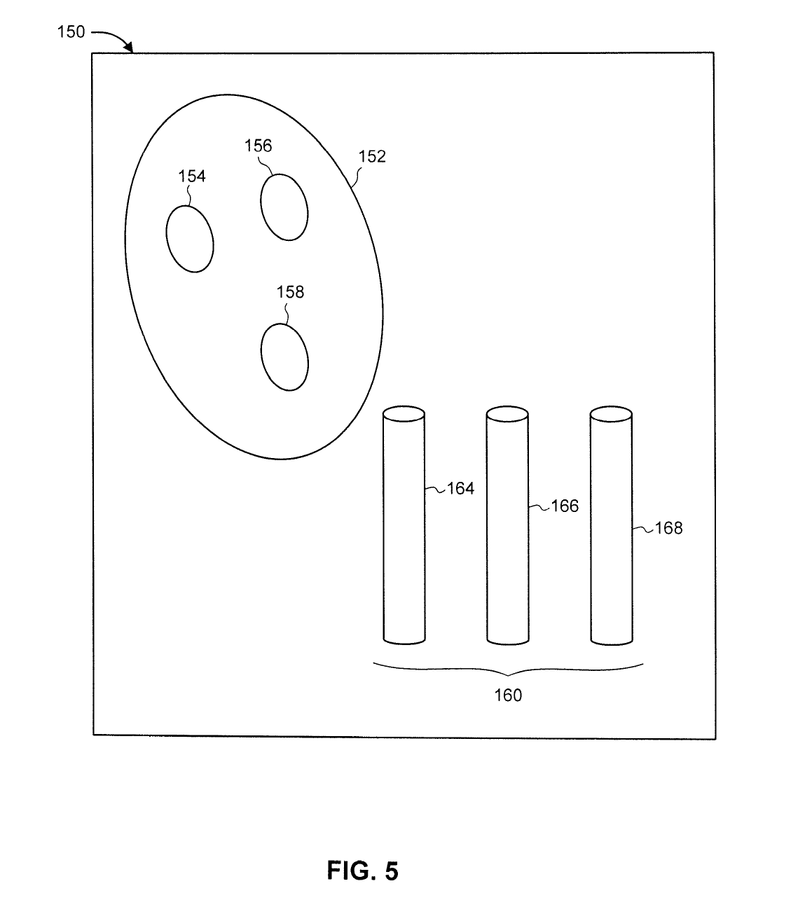

A soap kit of the disclosed technique may include scented soap pieces, unscented soap pieces, or a combination thereof. Reference is now made to FIG. 5, which is a schematic illustration of a soap kit, generally referenced 150, with scented and unscented soap pieces, constructed and operative in accordance with another embodiment of the disclosed technique. Soap kit 150 includes soap pieces 152, 162, 164 and 166. Soap piece 152 is unscented, lacking a distinct or noticeable odor or fragrance, while soap pieces 162, 164 and 166 (collectively referenced 160) are scented, each associated with a unique or common odor or fragrance. Soap piece 152 includes a plurality of indentations 154, 156 and 158, which geometrically conform with scented soap pieces 160, such that each of scented soap pieces 162, 164, 166 securely fits within a respective indentation 154, 156 and 158. Soap kit 150 may be assembled into an integrated soap unit having a particular fragrance or combination of fragrances, resulting from scented soap pieces 162, 164, 166, which can provide a pleasant aroma while using the soap. A non-aromatic soap unit may thus be transformed into an aromatic soap unit by incorporating at least one scented soap piece in its assembly.

A soap kit may include interchangeable soap pieces which are identical in shape and size but each associated with a different fragrance, such that one may select a desired fragrance for the assembled soap unit by performing the assembly with the respective soap piece having the desired fragrance. A fragrant soap unit may be assembled from multiple soap kits, such as using unscented soap pieces from a non-aromatic soap kit together with scented soap pieces of an aromatic soap kit, to produce an integrated soap unit having a desired fragrance (or fragrances).

According to an embodiment of the disclosed technique, the soap kit may include supplementary non-soap components intended to be used in conjunction with the soap pieces, such as to provide some kind of aesthetic or functional enhancement. Each non-soap component is configured to engage with a geometrically conforming portion of at least one soap piece in the soap kit. For example, a non-soap component may include one end which is shaped and sized to fit within a respective indentation of one of the soap pieces. The non-soap components may be made from any suitable material (e.g., plastic) and can be used to provide a soap unit with a particular characteristic. For example, the soap kit may include small perfume capsules, each containing a perfume with a unique fragrance, such that one may select a particular desired fragrance and then insert the perfume capsule with that fragrance into a complementary soap piece. Similarly, one may insert a number of perfume capsules into the soap piece, in order to achieve a desired combination of fragrances. The non-soap components may alternatively be a type of item or product that can be used in conjunction with the soap unit while washing or bathing. For example, the soap kit may include small containers with different types of hygienic products (e.g., one with shampoo, one with hair conditioner, one with skin moisturizer), or different colored markers or crayons (e.g., for coloring with the soap unit). Further alternatively, non-soap components may be utilized to provide ornamental characteristics to the unified soap unit, such as to represent the legs or arms of a robot or creature embodied by the soap unit. Non-soap components may be integrated within a single soap kit together with the corresponding soap pieces, or may be part of a separate kit, which may be purchased separately. Accordingly, non-soap components may be adapted to be used in conjunction with soap pieces of multiple different soap kits.

The soap kit of the disclosed technique is intended primarily as a toy or novelty item for children, such as to provide amusement and enjoyment, although may generally be used by any person of any age. The soap kit may be made available for purchase in stores or from retail suppliers. The soap kit may also be integrated with other products available for purchase, such as being sold as part of a children's meal at a restaurant, or being included inside a breakfast cereal. A prospective consumer may be able to select a preferred soap kit having certain characteristics, such as a soap unit depicting a particular image or constituting a particular object, or a soap kit containing scented soap pieces with particular fragrances. The soap kit may be used for merchandising, such as being associated with a promotional sales campaign for another consumer product (e.g., to promote a popular movie, television show or sports team). For example, a soap unit depicting the likeness of a popular actor may be available for purchase together with a DVD of the actor's latest film.

It will be appreciated by persons skilled in the art that the technique is not limited to what has been particularly shown and described herein above.

1. A soap kit comprising a plurality of soap pieces for assembly, each one of said soap pieces being configured to engage with a geometrically conforming portion of at least another complementary one of said soap pieces, such that said soap pieces can be collectively arranged to form an integrated soap unit.

2. The soap kit of claim 1, wherein a complementary group of said soap pieces are engaged while at least one of said complementary group of said soap pieces is in a wet state, to facilitate their adhesion.

3. The soap kit of claim 2, wherein at least one of said complementary group of said soap pieces is transitioned from a wet state to a dry state, to reinforce said adhesion and to facilitate the solidification of said soap unit.

4. The soap kit of claim 1, wherein said soap unit depicts a representation of an image.

5. The soap kit of claim 1, wherein said soap unit constitutes a representation of an object.

6. The soap kit of claim 5, wherein said soap unit erodes over time, changing the appearance of an initial representation.

7. The soap kit of claim 6, wherein the erosion of said soap unit reveals a representation of at least one new image or object by said soap unit.

8. The soap kit of claim 7, wherein the erosion of said soap unit at different stages reveals a sequential pattern of images or objects by said soap unit.

9. The soap kit of claim 1, wherein said soap pieces are configured as a two-dimensional or three-dimensional tiling puzzle, such that said integrated soap unit represents a completed puzzle.

10. The soap kit of claim 1, wherein at least one of said soap pieces comprises at least one indentation that geometrically conforms with a portion of at least another complementary one of said soap pieces.

11. The soap kit of claim 10, wherein said complementary one of said soap pieces is frictionally retained within a corresponding said indentation during assembly.

12. The soap kit of claim 1, wherein a complementary group of said soap pieces comprises at least one coupling mechanism selected from the list consisting of:
complementary ridges and grooves;
complementary tabs and recesses;
complementary interlocking portions; and
adhesive coatings.

13. The soap kit of claim 1, wherein at least one of said soap pieces is a scented soap piece.

14. The soap kit of claim 1, further comprising at least one supplementary non-soap component, configured to engage with a geometrically conforming portion of at least one of said soap pieces.

15. A method for assembling a plurality of soap pieces into an integrated soap unit, the method comprising the procedure of
collectively arranging the soap pieces of a soap kit relative to one another, by engaging at least one of said soap pieces with a geometrically conforming portion of at least another complementary one of said soap pieces.

16. The method of claim 15, further comprising the procedure of wetting at least one of a complementary group of said soap pieces prior to engaging said complementary group of said soap pieces, to facilitate their adhesion.

17. The method of claim 16, further comprising the procedure of transitioning at least one of said soap pieces from a wet state to a dry state, to reinforce said adhesion and to facilitate the solidification of said soap unit.

18. The soap kit of claim 4, wherein said soap unit erodes over time, changing the appearance of an initial representation.
